(19) United States
(12) Patent Application Publication
(10) Pub. No.: US 2017/0013373 A1
(43) Pub. Date: Jan. 12, 2017

(54) METHOD FOR SIGNAL PROCESSING FOR A HEARING DEVICE, HEARING DEVICE, HEARING DEVICE SYSTEM, AND INTERFERENCE SOURCE TRANSMITTER FOR A HEARING DEVICE SYSTEM

(71) Applicant: SIVANTOS PTE. LTD., SINGAPORE (SG)

(72) Inventors: BERND TESSENDORF, ERLANGEN (DE); SIMON HUETTINGER, ERLANGEN (DE); MATTHIAS FROEHLICH, ERLANGEN (DE); ROBERT BAEUML, ECKENTAL (DE)

(21) Appl. No.: 15/202,769

(22) Filed: Jul. 6, 2016

(30) Foreign Application Priority Data
Jul. 6, 2015 (DE) 10 2015 212 612.9

(51) Int. Cl. H04R 25/00

(52) U.S. Cl. CPC H04R 25/554; H04R 25/505; H04R 2225/51; H04R 2225/55; H04R 2410/05

(57) ABSTRACT

In a method for signal processing in a hearing device, an acoustic noise signal is received by a microphone of the hearing device and processed by a signal processing unit of the hearing device for output to a hearing device user. An electromagnetic information signal is received by a receiving unit of the hearing device. From this information signal, a piece of information about an acoustic interference signal which is contained in the acoustic noise signal is derived. This piece of information is taken into account during the processing of the acoustic noise signal for reducing the acoustic interference signal.

### CROSS-REFERENCE TO RELATED APPLICATION

This application claims the priority, under 35 U.S.C. §119, of German application DE 10 2015 212 612.9, filed Jul. 6, 2016; the prior application is herewith incorporated by reference in its entirety.

### BACKGROUND OF THE INVENTION

### Field of the Invention

The present invention relates to a method for signal processing for a hearing device, in particular for a hearing aid. In addition, the present invention relates to a hearing device as well as a hearing device system. Furthermore, the present invention relates to an interference source transmitter for a hearing device system.

The term “hearing device” typically contains various devices which are used for outputting audio signals to an ear or the hearing center of a user (“wearer”) of the particular device. In addition to so-called hearing aids, which are provided to people with hearing loss, the term “hearing device” also contains, inter alia, headsets, tinnitus maskers, and the like.

Hearing aids are in particular used to at least partially compensate for the limitations in hearing capability resulting in persons with hearing loss. Wearers of hearing aids generally wish to wear the hearing aid permanently and without affecting their quality of life if possible. In addition to technical hearing (acoustic) requirements, hearing aids must therefore also satisfy the requirements for (wearing and operating) convenience and esthetics. Here, in particular a small and light design is of particular importance in the hearing device technology.

Hearing aids normally include at least one microphone for picking up acoustic input signals. In addition, hearing aids usually include an earpiece (also referred to as a loudspeaker) as an output unit, via which acoustic output signals, mostly in amplified form, are transmitted to the wearer of the hearing aid. Cochlear or bone conduction implants are also used as output units in some cases.

In order to convert the input signal into the output signal, hearing aids typically have a signal processing unit. In this unit, the input signal is processed and thereby converted into the output signal using filtering and computing algorithms. For providing the required energy, hearing aids usually also include a battery.

During signal processing, in particular undesirable interference signals (for example, noise, interfering background noise or ambient noise) in the detected input signal are detected and subsequently reduced by filtering and computing algorithms. However, as is known, the required computing operations are energy-intensive and thus result in a reduction of the lifetime of the particular battery, which is usually small due to limited space.

In order to be able to blank out undesirable interference signals in a particularly simple manner, for example, it is known in published, European patent application EP 2 312 579 A1 to place a separate microphone in the area of the motor of a vehicle. The noise detected by the microphone is then, for example, used in a telecommunication device for interference noise suppression.

### SUMMARY OF THE INVENTION

The object of the present invention is to reduce the required power of a hearing device.

The method according to the present invention is used for (in particular acoustic) signal processing for a hearing device. For this purpose, an acoustic noise signal is received and preferably converted into an electrical signal (“input signal”) by a microphone of the hearing device. In addition, an electromagnetic information signal is received via a receiving unit. A piece of information about an acoustic interference signal which is contained in the received noise signal is derived from this information signal. The noise signal, preferably the input signal generated from it, is processed for output to a hearing device user by a signal processing unit of the hearing device. The piece of information obtained from the information signal via the interference signal is taken into account in order to reduce the interference signal (contained in the noise signal or the input signal). Preferably, the processed input signal is transmitted as an output signal to an output unit of the hearing device, preferably to a loudspeaker, for output to the hearing center of the hearing device user.

Here and below, acoustic signal processing may be understood to mean the processing of the detected acoustic noise signal in particular by electronic means. Thus, the acoustic noise signal is processed in the form of the electrical input signal preferably by the (electronic) signal processing unit. The signal processing preferably includes an analysis (supported by computing operations) of the input signal in particular with regard to interfering noise—noise or other background noise—a reduction of such interfering noise, and advantageously, amplification of relevant (“useful”) signals which are contained in the input signal, for example, speech, music, and the like.

An interference signal, to which the characteristic piece of information derived from the information signal is directed, may be understood here and below to mean noise output by an in particular electrical source (“interference source”), i.e., an electric device or a comparable source, which normally has only negligible information content for a hearing device user and in particular usually results in a reduction of the comprehensibility of useful signals contained in the acoustic noise signal, for example, speech.

As a result of the piece of information about the interference signal which is contained in the received noise signal being derived from the information signal, a computation-intensive and energy-intensive ascertainment of the interference signal in particular via analysis of the input signal in the signal processing unit may advantageously be omitted. Rather, on the basis of the piece of information derived from the information signal, the interference signal associated with a specific interference source is directly (i.e., without previous analysis steps) reduced. This advantageously results in a conservation of computing power and a reduction of the energy required by the hearing device.

In one advantageous embodiment of the method, an acoustic sound profile of the interference signal is derived from the information signal as a piece of information about the interference signal. Such a sound profile is preferably formed by a frequency profile over time. As a result, the derived sound profile (in particular the frequency profile) may be taken directly into account in a simple and energy-conserving manner directly for reducing the interference signal in the input signal, for example, in that the signal components contained in the sound profile, in particular the frequencies contained, are filtered out of the input signal (in particular attenuated or blanked out).

In one preferred embodiment of the method, the sound profile derived from the information signal represents in particular a time-invariant piece of information. Here and below, a time-invariant piece of information may be understood to be a static piece of information which does not change over an in particular comparatively long period of time (for example, several minutes) or is preferably completely constant. In this case, the derived sound profile is, for example, a comparatively short (for example, lasting 1 to 3 seconds) frequency profile of the interference signal, which is referred to as a “sample,” which in particular is continuously ascertained repeatedly from the information signal. This frequency profile or the sample depicts the interference signal (in particular repeatedly concatenated) over a comparatively long period of observation (for example, of 20 seconds to several minutes), in a manner which is approximately constant over time. Alternatively, however, within the scope of the present invention, it is also conceivable that an (in particular constant) frequency range (a “frequency band”) in which the interference signal lies is ascertained as a sound profile from the information signal.

In one preferred embodiment of the method, the interference signal contained in the noise signal is attenuated during the signal processing. Thus, the reduction of the interference signal is an attenuation. Here and below, attenuation may be understood to mean that the interference signal is attenuated by a factor of greater than 0 and less than 1. Thus, the power of the interference signal is reduced in comparison to its input power. As a result, the sound spectrum of the detected noise signal is retained to the greatest possible extent, wherein, however, the interference signal is attenuated to a level which is negligible or at least which does not impair the hearing device user.

In an alternative embodiment of the method, the interference signal contained in the noise signal is completely blanked out of the input signal (“canceled”). Thus, an output signal having a sound spectrum which is reduced with respect to the detected noise signal is provided to the hearing device user, so that the hearing device user is not distracted by irrelevant (interference) noise.

Preferably, in both cases (i.e. during the attenuation or blanking out of the interference signal), during signal processing, frequencies which are not contained in the information signal or the sound profile obtained from it, and for which slight interference is to be expected, are accentuated (for example, amplified).

In an additional advantageous embodiment of the method, in particular a time-variant (“dynamic”) piece of information about the interference signal is derived from the information signal (instead of the time-invariant piece of information described above). Here and below, a time-variant or dynamic piece of information may be understood to mean that it contains a statement about a temporal change in a signal. The ascertainment of a time-variant piece of information from the information signal thus makes it possible to take into account a variable (in particular in a period of 5 seconds up to several minutes) signal profile (in particular frequency profile). Advantageously, a continuous frequency profile, in particular fluctuating over a comparatively long period, is ascertained from the information signal, which preferably depicts the actual state of the interference signal at any point in time (i.e., continuously updated). For example, statements about the start, end, and/or changes in the sound profile of the particular (electrical) interference source are also ascertained as a piece of time-variant information, which will occur in particular in a short period of time, for example, in the next 1 to 3 seconds. In particular, within the scope of the present invention, in this case, it is, for example, ascertained that the interference signal switches to another frequency range in a predefined period of time, or the sound profile of the interference source corresponds to a “different” sample (also ascertained from the information signal) as of a predefined point in time. Therefore, in the case of the ascertainment of a time-variant piece of information from the information signal, not only are statements derived about the current (variable) actual state of the interference signal, but preferably also about expected changes in the interference signal at particular points in time. As a result, delays in the signal processing between the occurrence of (or the change in) an interference signal and its being taken into account in the signal processing may advantageously be reduced.

According to the method, in addition to the piece of information described above directed to the acoustic characteristics of the interference signal, an additional piece of information (also referred to as background information) for the interference signal is derived from the information signal. This additional piece of information in particular contains no statement about the sound profile of the interference signal. Preferably, this additional piece of information is the identity of the interference source, i.e., the type of interference source, in particular, the specific device forming the interference source. For example, it is ascertained as an additional piece of information that the interference source is a kitchen device (for example, a refrigerator), a car engine, or an air conditioner. Preferably in the embodiment of the method, in addition, specifications stored (in the signal processing unit) are accessed, which specify different values (factors) for reducing the corresponding interference signal for different types of interference sources. In other words, during the signal processing, as a function of the ascertained additional piece of information, the interference signal which is associated with this piece of information is reduced in particular by a specifically predefined value in each case. As a result, a particularly high adaptability of the signal processing, in particular of the interference signal reduction, to a plurality of interference signals is made possible, but with little computing effort.

In one advantageous refinement of the method, in particular in the case that the additional piece of information (preferably the identity of the interference source) is derived from the information signal, user-specific specifications are taken into account during the signal processing, in particular during the reduction of the interference signal. This is in particular advantageous, since the personal perception of noise, in particular of background or ambient noise, is often different between individual users (hearing device users). For example, one user perceives noise in the frequency range of electrical devices, for example, fans, air conditioners, etc., as unpleasant, whereas another user might perceive such noise in an attenuated manner. By taking into account the user-specific specifications when reducing the particular interference signal, it is thus possible to increase the individual comfort of use of the hearing device.

In one advantageous embodiment of the method, an electromagnetic signal provided (i.e., output) by a transmitter referred to as an interference source transmitter is used as an information signal. Such an interference source transmitter is, for example, integrated into an electrical device which constitutes an interference source. Alternatively, such an interference source transmitter is attached to this device, for example, in the form of an (adhesive) “tag”. Preferably, the receiving unit is also configured to receive multiple different information signals (simultaneously), so that, depending on the number of interference source transmitters arranged in the reception area of the hearing device, it is thus also possible to take into account different interference signals during signal processing.

In one advantageous embodiment of the method, the particular information signal is received passively. Thus, the receiving unit is in particular operated continuously in a receiving mode. Therefore, if an information signal is detected by the receiving unit, it is also taken into account during the signal processing of the acoustic noise signal.

In an alternative embodiment of the method, on the other hand, a query signal is (“actively”) transmitted, in order to activate the transmission of the information signal (in the case of an interference source transmitter which is possibly arranged in the range of the query signal). In other words, in this case, the hearing device actively searches for available interference source transmitters. This is in particular advantageous in the case that the interference source transmitter is not a “continuously transmitting” transmitter, but rather, for example, an RFID chip or the like. In this case, the information signal is transmitted by the interference source transmitter only if a receiver (i.e., the hearing device) is in range.

The hearing device according to the present invention is in particular a hearing aid. The hearing device includes at least one microphone for receiving acoustic noise signals. In addition, the hearing device includes a receiving unit for receiving an electromagnetic information signal. This receiving unit is preferably an antenna, for example, a wire coil. In addition, the hearing device includes a signal processing unit which is configured to carry out the above-described method. Thus, the signal processing unit is configured to ascertain the (time-invariant or dynamic) piece of information about the interference signal contained in the noise signal from the information signal received by the receiving unit. In addition, the signal processing unit is configured to take into account this piece of information during the signal processing of the noise signal (or of the input signal generated from it) for reducing the interference signal.

The hearing device system according to the present invention includes the above-described hearing device. In addition, the hearing device system includes at least one interference source transmitter. This transmitter is configured to output (transmit) an information signal which contains at least one piece of information about the acoustic interference signal. The, or each, interference source transmitter is preferably associated with a specific device which outputs an acoustic interference signal, in particular is integrated into it. Alternatively, the interference source transmitter is configured to be attached to such a device. In the latter case, the interference source transmitter is in particular a “tag”, which is configured as a sticker having an integrated antenna and microchip. Preferably, the microchip of the particular tag is programmable to a specific interference signal. Thus, in its delivery state, the tag does not (yet) transmit a signal, but does so only if an information signal which is to be output specifically is stored in the microchip via a programming step. This programming step may, for example, be carried out by a hearing device acoustician. Alternatively, however, within the scope of the present invention, it is also conceivable that the interference source transmitter has a microphone and is configured to detect the acoustic interference signal emitted by the interference source and to output it in electromagnetic form as an information signal to the hearing device. The use of one or multiple interference source transmitters makes the detection and taking into account of interference signals particularly simple. For example, it is conceivable that an interference source transmitter is associated in each case at least with the interference sources which the hearing device user finds particularly disturbing, at least in a living area and/or at the workplace of the hearing device user.

Preferably, the particular interference source transmitter, which is also regarded as an autonomous invention, is configured to transmit at a power level and frequency which lie in the range of so-called near-field communication. Here, near-field may be understood to be a range of up to approximately 5 m around the particular interference source transmitter. At such a distance from the interference source, typical ambient noise in the detected noise signal generated by this interference source (for example, a refrigerator, an air conditioner, or a fan) is generally found to be disturbing.

In addition, the interference source transmitter is advantageously also configured and provided to transmit the sound profile of the particular associated sound source preferably directly in the information signal. In particular, the interference source transmitter is configured to transmit the sound profile as a frequency profile. As a result, taking into account the sound profile in the noise signal is particularly simple, since the particular “interference frequency” may be blanked out of the input signal or attenuated in particular by means of subtraction. Optionally, the interference source transmitter is also configured to additionally transmit the identity of the interference source in the information signal.

Other features which are considered as characteristic for the invention are set forth in the appended claims.

Although the invention is illustrated and described herein as embodied in a method for signal processing for a hearing device, a hearing device, a hearing device system, and an interference source transmitter for a hearing device system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic representation of a hearing device system according to the invention; and

FIG. 2 is a flow chart of a method for signal processing in the hearing device of the hearing device system.

### DETAILED DESCRIPTION OF THE INVENTION

Corresponding parts and variables are provided with identical reference numerals in all figures.

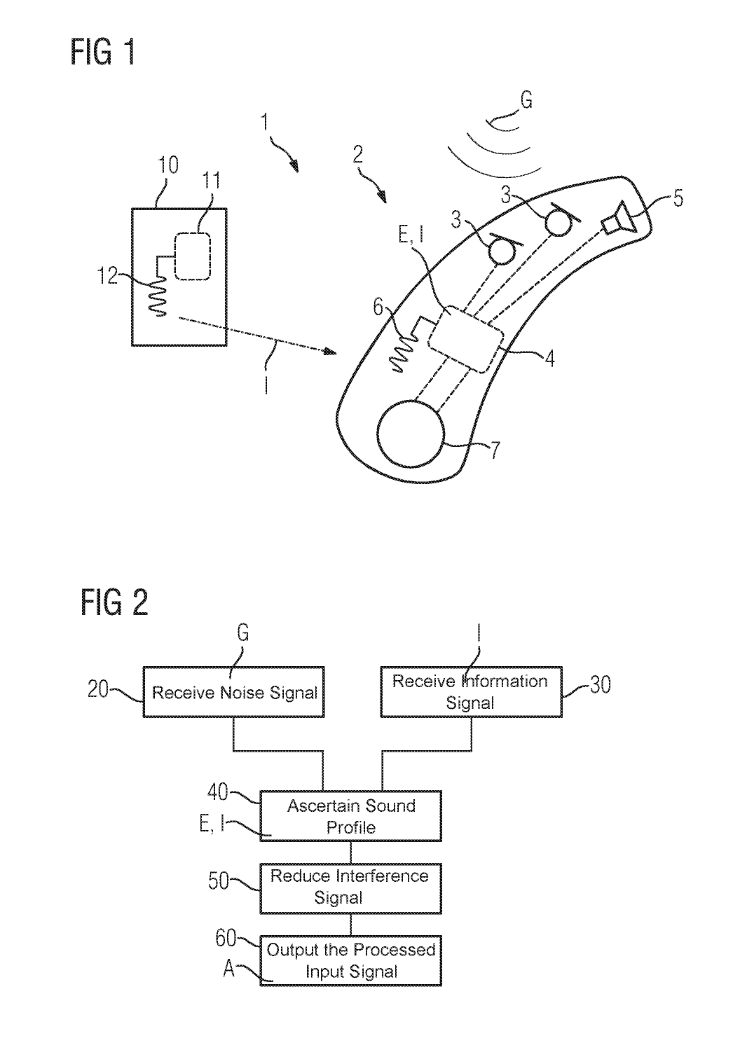

Referring now to the figures of the drawings in detail and first, particularly to FIG. 1 thereof, there is shown a hearing device system 1. The hearing device system 1 includes a hearing device 2. The hearing device 2 has two microphones 3 for detecting an acoustic noise signal G (see schematically depicted sound waves) and converting the same into an electrical input signal E. For processing the detected noise signal G or the input signal E, the hearing device 2 has a signal processing unit 4 which is interconnected with the microphones 3 for transmitting the input signal E. For outputting the processed input signal E to an ear of a hearing device user, the hearing device 2 has a loudspeaker 5 (also referred to as an “earpiece”) which is downstream from the signal processing unit 4. In addition, the hearing device 2 has a receiving unit in the form of an antenna 6 for detecting electromagnetic signals. For supplying energy, the hearing device 2 furthermore has a battery 7.

In addition to the hearing device 2, the hearing device system 1 has an interference source transmitter 10. The interference source transmitter 10 is configured and provided to be arranged at an acoustic interference source—a device which outputs an acoustic noise which is superimposed on “desirable” useful signals (contained in the noise signal G) such as speech and/or music and thus reduces their audibility—and to emit an information signal I. This information signal I contains a piece of information about the acoustic characteristics of the noise output by the interference source. The latter is referred to below as an acoustic interference signal. Specifically, the information signal I contains a sound profile of the interference signal in the form of a frequency profile (over time). The interference source transmitter 10 has a structural component which is referred to as a chip 11, in which the information signal I is stored and which contains an energy source. For transmitting (outputting) the information signal I, the interference source transmitter 10 also has a transmitting antenna 12. The chip 11 and the transmitting antenna 12 are applied to an adhesive foil 13, by which the interference source transmitter 10 may be attached to the corresponding interference source.

During the operation of the hearing device system 1, a method, which is described below in greater detail based on FIG. 2, is carried out by the hearing device 2. In this case, the interference source transmitter 10 is associated with an interference source (not shown in detail) as intended and programmed in such a way that the electromagnetic information signal I matched to the interference source is output (at a frequency of 866 MHz in the UHF band) by the transmitting antenna 12. In the present exemplary embodiment, the interference source is specifically a refrigerator which includes a compressor for generating the cooling output. During operation, this compressor generates the interference signal in the form of “humming.” The information signal I thus contains a frequency profile reflecting the humming of the compressor.

In a method step 20, the hearing device 2 receives the noise signal G, which, in the present example, is made up of a useful signal (language) and the interference signal of the refrigerator, by the microphones 3. The microphones 3 convert the acoustic noise signal G into the electrical input signal E and pass the latter to the signal processing unit 4. In a method step 30, the hearing device 2 receives the information signal I by the antenna 6. This signal is also passed to the signal processing unit 4. In an additional method step 40, the signal processing unit 4 ascertains a piece of information about the interference signal from the information signal I, specifically, the sound profile of the interference signal.

In an additional method step 50, the signal processing unit 4 reduces the interference signal in the input signal E, in that the frequency profile contained in the information signal is blanked out of the input signal E. The useful signal remaining after this blanking out is subsequently amplified in such a way that it lies above the individual hearing threshold of the hearing device user and may thus be perceived by the user. Subsequently, in a following method step 60, the input signal E processed in such a way is passed as an output signal A to the loudspeaker 5 for acoustic output to the ear of the hearing device user.

As a result of the hearing device 2 deriving the acoustic characteristics (the sound profile) of the interference signal directly from the information signal I, complex computation operations for detecting interference signals and cleaning them in the input signal E may advantageously be omitted. Thus, energy-conserving operation is possible while also reducing interference signals in a particularly precise manner.

In an additional exemplary embodiment, the information signal I also contains, in addition to the sound profile of the interference signal, a specification of the kind of interference source from which the interference signal is output. Thus, in addition to the frequency profile reflecting the humming of the compressor, the information signal I also contains the additional piece of information that the interference source is the refrigerator. The signal processing unit 4 derives this additional piece of information from the information signal I in the method step 40. In the method step 50, the signal processing unit 4 derives a parameter set from a data memory which is not shown in greater detail, which is associated with the interference source “refrigerator” and which contains values for the reduction of an interference signal output by a refrigerator. In addition, this parameter set is stored in a user-specific manner in the data memory and is thus adapted to preferences of the hearing device user with regard to different interference sources. In the present exemplary embodiment, the parameter set contains specific values for attenuating, i.e., not completely blanking out, the interference signal in the input signal E according to the wishes of the hearing device user. In this case, the interference signal is retained in the output signal in an attenuated form, so that the hearing device user is able to hear the refrigerator faintly, without the useful signal being distorted.

The object of the present invention is not limited to the above-described exemplary embodiments. Rather, additional specific embodiments of the present invention may be derived from the above description by those skilled in the art. In particular, the individual features of the present invention described based on the various exemplary embodiments and their embodiment variants may also be combined in a different manner.

The following is a summary list of reference numerals and the corresponding structure used in the above description of the invention:
1 Hearing device system
2 Hearing device
3 Microphone
4 Signal processing unit
5 Loudspeaker
6 Antenna
7 Battery
10 Interference source transmitter
11 Chip
12 Transmitting antenna
20 Method step
30 Method step
40 Method step
50 Method step
60 Method step
G Noise signal
E Input signal
I Information signal
A Output signal

1. A method for signal processing for a hearing device, which comprises the steps of:
receiving an acoustic noise signal by a microphone;
processing the acoustic noise signal for output to a hearing device user by a signal processing unit;
receiving an electromagnetic information signal by a receiving unit;
deriving a piece of information about an acoustic interference signal being contained in the acoustic noise signal from the electromagnetic information signal; and
deriving an additional piece of information from the electromagnetic information signal, which relates to a source of the acoustic interference signal, the piece of information about the acoustic interference signal and the additional piece of information which relates to the source of the acoustic interference signal are taken into account during the processing of the acoustic noise signal for reducing the acoustic interference signal.

2. The method according to claim 1, which further comprises deriving an acoustic sound profile from the electromagnetic information signal as the piece of information about the acoustic interference signal.

3. The method according to claim 1, which further comprises attenuating the acoustic interference signal for purposes of reduction.

4. The method according to claim 1, which further comprises blanking out the acoustic interference signal for purposes of reduction.

5. The method according to claim 1, which further comprises deriving a time-variant piece of information from the electromagnetic information signal.

6. The method according to claim 1, which further comprises taking into account user-specific specifications for reducing the acoustic interference signal.

7. The method according to claim 1, which further comprises using a signal transmitted by an interference source transmitter as the electromagnetic information signal.

8. The method according to claim 1, which further comprises outputting a query signal in order to activate a transmission of the electromagnetic information signal.

9. A hearing device, comprising:
a microphone for receiving an acoustic noise signal;
a receiving unit for receiving an electromagnetic information signal; and
a signal processing unit programmed to:
receive the acoustic noise signal from said microphone;
process the acoustic noise signal for output to a hearing device user;
receive the electromagnetic information signal from said receiving unit;
derive a piece of information about an acoustic interference signal being contained in the acoustic noise signal from the electromagnetic information signal; and
derive an additional piece of information from the electromagnetic information signal, which relates to a source of the acoustic interference signal, the piece of information about the acoustic interference signal and the additional piece of information which relates to the source of the acoustic interference signal are taken into account during the processing of the acoustic noise signal for reducing the acoustic interference signal.

10. A hearing device system, comprising:
a hearing device having a microphone for receiving an acoustic noise signal, a receiving unit for receiving an electromagnetic information signal, and a signal processing unit programmed to:
receive the acoustic noise signal from said microphone;
process the acoustic noise signal for output to a hearing device user;
receive the electromagnetic information signal from said receiving unit;
derive a piece of information about an acoustic interference signal being contained in the acoustic noise signal from the electromagnetic information signal; and
derive an additional piece of information from the electromagnetic information signal, which relates to a source of the acoustic interference signal, the piece of information about the acoustic interference signal and the additional piece of information which relates to the source of the acoustic interference signal are taken into account during the processing of the acoustic noise signal for reducing the acoustic interference signal; and
an interference source transmitter configured to transmit the electromagnetic information signal, the electromagnetic information signal containing the piece of information about the acoustic interference signal contained in the acoustic noise signal detected by said hearing device and the additional piece of information which relates to a source of the acoustic interference signal.

11. An interference source transmitter system for a hearing device system, the interference source transmitter system, comprising:
an interference source transmitter configured to transmit an electromagnetic information signal, the electromagnetic information signal containing a piece of information about an acoustic interference signal contained in an acoustic noise signal detected by a hearing device, and an additional piece of information relating to a source of the acoustic interference signal.
